(19) United States
(12) Patent Application Publication
(10) Pub. No.: US 2016/0098675 A1
(43) Pub. Date: Apr. 7, 2016

(54) METHODS AND SYSTEMS FOR INVENTORY CONTROL

(71) Applicant: Device Cloud Networks, Rockville, MD (US)

(72) Inventor: John Carvalho, Malvern, PA (US)

(21) Appl. No.: 14/874,364

(22) Filed: Oct. 2, 2015

Related U.S. Application Data
(60) Provisional application No. 62/059,830, filed on Oct. 3, 2014.

(51) Int. Cl. G06Q 10/08; H04W 8/00

(52) U.S. Cl. CPC G06Q 10/087; H04W 8/005

(57) ABSTRACT

According to one aspect, the subject matter described herein includes a method for inventory control. In one embodiment, the method includes storing and maintaining expected associations between international mobile equipment identity (IMEI) values and international mobile subscriber identity (IMSI) values, monitoring signaling in a wireless network to determine observed associations between IMEI values and IMSI values, and determining whether an observed association involving an IMEI value and an IMSI value differs from the expected association for the IMEI or IMSI value. If the observed association differs from the expected association, a target action may be performed.

### CROSS REFERENCE TO RELATED APPLICATION

This application claims benefit of and priority to U.S. Provisional Patent Application No. 62/059,830 entitled “Methods and Systems for Inventory Control,” (Attorney Docket No. 464/2 PROV) which was filed on Oct. 3, 2014, the contents of which are incorporated by reference herein.

### TECHNICAL FIELD

The present invention relates to inventory control, and more specifically, to performing a target action in response to determining that an observed association involving an IMEI value and an IMSI value differs from the expected association for the IMEI or IMSI value.

### BACKGROUND

Machine-to-machine, or “M2M”, communication may take advantage of the nearly ubiquitous nature of cellular networks to provide a backbone for global M2M communication. To do this, manufacturers may incorporate cellular transceivers, such as are found in mobile telephones, into manufactured goods and equipment for the purpose of M2M communication between equipment. Each cellular transceiver is associated with a unique identifier, such as an international mobile equipment identifier, or IMEI, which is used by a GSM network to identify valid devices. Mobile telephones are also associated with an international mobile subscriber identifier, or IMSI, which is used to uniquely identify a subscriber of the network. IMSI identifies a user of the equipment and IMEI identifies the equipment itself.

Either or both of these identifiers may be included in the signaling messages associated with a cell phone or other mobile device. Typically, each piece of equipment has its own IMEI hardwired into a circuit board, while the IMSI number is stored in a subscriber identity module (SIM), or SIM card, which is connected to a cell phone, for example. In early implementations, SIM cards were removable, but a recent trend is to solder the SIM card to a circuit board of the cell phone in order to make it difficult to transfer the SIM card—and the IMSI contained within—from one piece of equipment to another, such as from an oldphone to a new phone. Although there is value in maintaining and monitoring the association or relationship between a subscriber and a particular piece of hardware, e.g., between IMSI and IMEI, the IMEI number has historically been used as a control for devices that have been reported as stolen—a function which can be performed using only the IMEI number without the need to know or maintain any association between IMEI and IMSI.

The same historical trend continues with M2M communication as well. For example, an equipment maker, such as an automobile manufacturing company, may combine a SIM card that includes an IMSI number with cellular equipment that has a unique IMEI and install it into a piece of equipment in a manner that makes the SIM card difficult to separate from the piece of equipment. Conventional uses of such equipment tend to focus on the cellphone capabilities alone, such as providing an in-car cellphone, providing push-button driver information or roadside assistance, or identifying and disabling stolen vehicles. None of these conventional uses requires an understanding of the association of IMSI and IMEI values.

The addition of hardwired SIM cards to equipment makes possible a number of capabilities, such as the use of IMSI or IMEI values for controlling, monitoring, and tracking inventory. In addition, the use of embedded universal integrated circuit cards, or eUICCs, for storing IMSI data, and the attendant ability of eUICC to be remotely programmed, makes possible an even wider range of capabilities, including the ability to remotely change the subscription on the mobile device in an intelligent manner, as well as the ability to provide fail-safe subscription. Conventional systems and devices do not implement any of these features.

Accordingly, a need exists for controlling, monitoring, and tracking inventory including the ability to remotely change the subscription on the mobile device in an intelligent manner and the ability to provide fail-safe subscription.

### SUMMARY

The subject matter disclosed herein includes systems and methods for inventory control.

According to one aspect, the subject matter described herein includes a method for inventory control, where the method includes storing and maintaining expected associations between international mobile equipment identity (IMEI) values and international mobile subscriber identity (IMSI) values, monitoring signaling in a wireless network to determine observed associations between IMEI values and IMSI values, and determining whether an observed association involving an IMEI value and an IMSI value differs from the expected association for the IMEI or IMSI value. If the observed association differs from the expected association, a target action may be performed.

According to another aspect, the subject matter described herein includes another method inventory control, where the method includes storing and maintaining associations between international mobile equipment identity (IMEI) values and serial numbers for equipment associated with each IMEI value, and using the association between serial numbers and IMEI values to determine information about equipment associated with a particular serial number or IMEI value.

According to yet another aspect, the subject matter described herein includes a system for inventory control. In one embodiment, the system includes a database having hardware and for storing and maintaining expected associations between international mobile equipment identity (IMEI) values and international mobile subscriber identity (IMSI) values, a monitoring module for monitoring signaling in a wireless network to determine observed associations between IMEI values and IMSI values, and an association determination module for determining whether an observed association involving an IMEI value and an IMSI value differs from the expected association for the IMEI or IMSI value, and, in response to determining that the observed association differs from the expected association, performing a target action.

According to yet another aspect, the subject matter described herein includes another system for inventory control. In one embodiment, the system includes a database having hardware and for storing and maintaining associations between international mobile equipment identity (IMEI) values and serial numbers for equipment associated with each IMEI value, and an association determination module for using the association between serial numbers and IMEI values to determine information about equipment associated with a particular serial number or IMEI value.

### BRIEF DESCRIPTION OF THE DRAWINGS

Embodiments of the subject matter described herein will now be explained with reference to the accompanying drawings, wherein the like reference numerals represent like parts, of which:

FIG. 1 is a flow chart illustrating an exemplary process for inventory control according to an embodiment of the subject matter described herein;

FIG. 2 is a block diagram illustrating an exemplary system for inventory control according to another embodiment of the subject matter described herein;

FIG. 3 is a flow chart illustrating an exemplary process for inventory control according to another embodiment of the subject matter described herein; and

FIG. 4 is a block diagram illustrating an exemplary system for inventory control according to yet another embodiment of the subject matter described herein.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Manufacturers are using cellular networks for machine-to-machine (M2M) communications between equipment, such as car, copiers, refrigerators, etc. Each piece of equipment has its own hardwired IMEI and contains the IMSI number in a SIM card or eUICC card. The manufacturer usually wants to make sure that the SIM is not moved from one piece of equipment to another, such as from one cell phone to another cell phone.

In a typical scenario, manufacturers have a business arrangement with a SIM or eUICC provider, which provides to the manufacturer SIM cards pre-loaded with IMSI numbers and other subscription information. The manufacturer or another equipment maker will provide a device having an IMEI. The manufacturer marries the SIM card to the piece of equipment and sells the finished product. Mobile network operators, or MNOs, typically use IMEI values for the purpose of blacklisting stolen cell phones or detecting the location of stolen vehicles based on their IMEI values.

In contrast, in the methods and systems described herein, an entity—which may be a third party, the manufacturer, or some other party—associates the IMEI number for a particular piece of equipment to the IMSI number contained in the SIM card that is attached to that particular piece of equipment, and stores that association in a database or other form of storage.

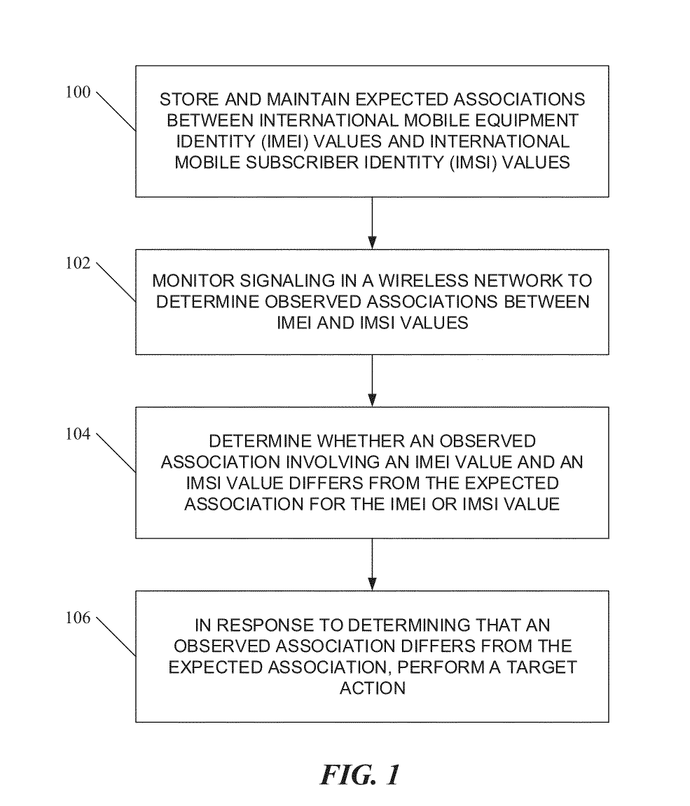

FIG. 1 is a flow chart illustrating an exemplary process for inventory control according to an embodiment of the subject matter described herein. In the embodiment illustrated in FIG. 1, the method includes, the following steps:

At step 100, expected associations between IMEI and IMS values are stored and maintained. At step 102, signaling in a wireless (or hybrid wired and wireless) network is monitored to determine observed associations between IMEI and IMSI values. At step 104, it is determined whether an observed IMEI/IMSI association differs from the association that was expected for that IMEI or IMSI. At step 106, in response to determining that an observed IMEI/IMSI association is different from what was expected, a target action is performed.

The information maintained by system 100, and the discrepancy detection that system 100 provides, have many useful applications:

In one embodiment, the association between IMEI and IMSI numbers may be used to control, track, or monitor inventory. In one embodiment, network signaling in a wireless network can be monitored to observe associations between IMEI values and IMSI values and to determine whether the pair of values is the same as the values stored in the database. If the observed pair of values is different from what is expected, a target action can be performed. Target actions include, but are not limited to, providing notification of the discrepancy (e.g., to the MNO, the manufacturer, or other entity); recording or logging the occurrence of the discrepancy; or performing some action related to the piece of equipment with which the IMEI value is associated.

For example, a mismatch between observed and expected IMEI and IMSI values could indicate removal of the SIM or eUICC card from the original equipment (which may indicate theft or disassembly of the equipment), in which case the target action may be to fully or partially disable the operation, a function, or a feature of the equipment. Other actions include, but are not limited to: disabling the ability of the equipment to communicate via a cellular network; changing a user, access, or billing profile associated with the equipment; and modifying the list of networks to which the piece of equipment may join.

In one embodiment, the expected association between IMEI and IMSI may be established and stored during a build step of a manufacturing process, which may be a manual manufacturing process, an automatic manufacturing process, or a combination of the two. For example, an assembly line which attaches the cellular communication module to the piece of equipment may provide the IMEI/IMSI pair to the database. Once established, the IMEI/IMSI relationship may be used to monitor the manufacturing process, e.g., by tracking the progress of a piece of equipment through an assembly line via cellular communication, and take action not only when an IMEI/IMSI discrepancy is detected, but also when a piece of equipment having a proper IMEI/IMSI value is detected in the wrong location, in the wrong assembly line, or even in the wrong plant.

Likewise, the IMEI/IMSI information may be used after the manufacturing step. For example, this information may be used to track finished products through the product distribution network or sales chain, and even throughout the rest of the product deployment or life cycle.

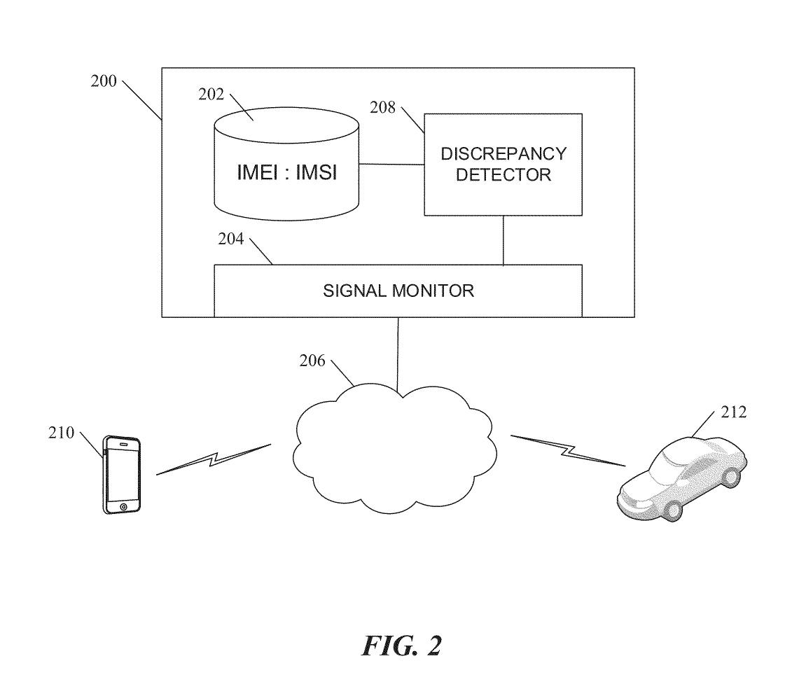

FIG. 2 is a block diagram illustrating an exemplary system for inventory control according to an embodiment of the subject matter described herein. In one embodiment, a system 200 for inventory control according to the principles described above may include a database 202 having hardware and for storing and maintaining expected associations between international mobile equipment identity (IMEI) values and international mobile subscriber identity (IMSI) values, a monitoring module 204 for monitoring signaling in a wireless or hybrid network 206 to determine observed associations between IMEI values and IMSI values, and an association determination module 208 for determining whether an observed association involving an IMEI value and an IMSI value differs from the expected association for the IMEI or IMSI value. In one embodiment, module 202 may include a database, table, or other means to store IMEI/IMSI relationships. In one embodiment, module 204 may include a network interface that receives or intercepts signaling messages from a telecommunications network. The system may include a server to which the hardware is associated with.

In response to detecting that an observed IMEI/IMSI relationship is not what was expected (i.e., a discrepancy), system 200 may perform a target action, which can include, but are not limited to, the target actions described above. For example, detection of an unexpected IMEI/IMSI pair in signaling messages from a cell phone or other mobile device 210 may indicate that the device has been stolen or tampered with. In this scenario, system 200 may take actions such as shutting down, locking, deleting user data from, or blocking access to networks from device 210. The same principles apply not only to traditional mobile devices 210 but also to equipment that may engage in M2M communication, such an automobile 212 or a stationary piece of equipment not shown in FIG. 2.

The relationship between IMEI and IMSI values is not the only one having a potential benefit for manufacturers. The IMEI value assigned to a given cellular transceiver may also be tied to serial numbers of parts of the equipment to which the IMEI number is assigned.

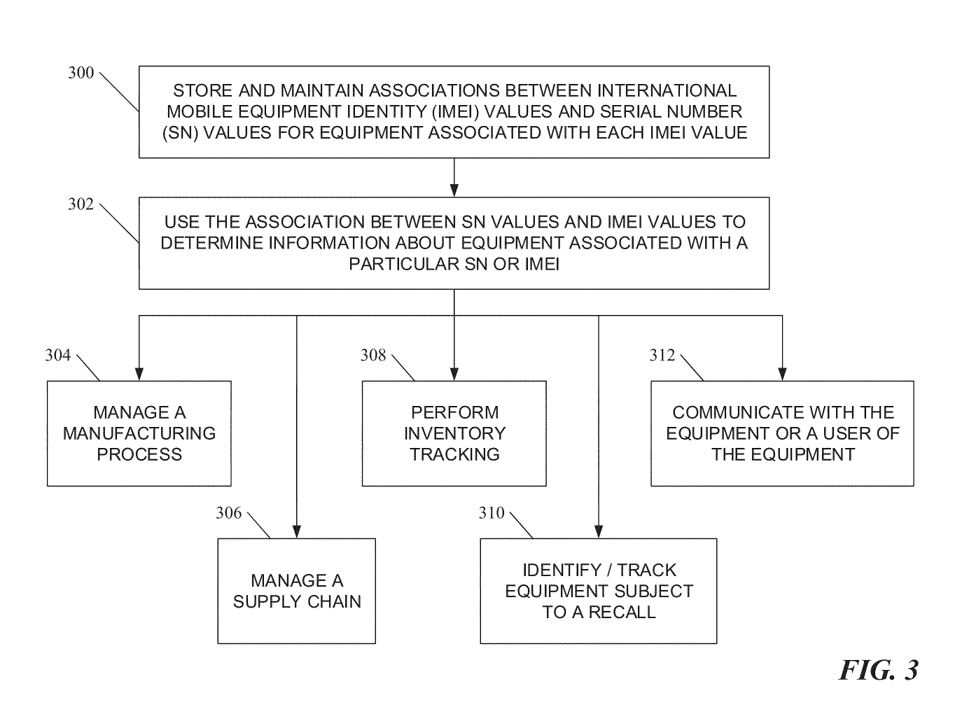

FIG. 3 is a flow chart illustrating an exemplary process for inventory control according to an embodiment of the subject matter described herein. In the embodiment illustrated in FIG. 3, the method includes, the following steps:

At step 300, expected associations between an IMEI and a serial number of equipment which is associated with that IMEI values are stored and maintained. At step 302, the association between IMEI and SN is used to determine information about equipment associated with a particular SN or IMEI. This information may be used to perform a variety of tasks, including, but not limited to, managing a manufacturing process 304, managing a supply chain 306, performing inventory tracking 308, or identifying and/or tracking equipment subject to a recall 310. In one embodiment, for example, the relationship between IMEI and SN can be used to communicate with the equipment or a user of the equipment. Each of these steps will be discussed in detail below.

In one embodiment, for example, a method for inventory control may include storing and maintaining associations between international mobile equipment identity (IMEI) values and serial numbers for equipment associated with each IMEI value. The association of IMEI to serial number (SN) may be used to determine information about equipment associated with a particular serial number, such as the current location of the equipment, which can be determined from network signaling, or the location history of the equipment. Other information that may be determined includes, but is not limited to, the date, time, or location of manufacture of the piece of equipment. This or other information may be used to identify other, related pieces of equipment, such as equipment that was made at the same facility. In one scenario, for example, the information associated with a piece of equipment that is subject to recall due to failure may be used to identify other pieces of equipment that may be likely to fail or that are at least worthy of additional testing or scrutiny to ensure that they don't also suffer a same or similar manufacturing or design flaw as the recalled equipment. This information, too, can be used to manage a manufacturing process or supply chain, for inventory tracking and/or control, and other uses.

For example, a car manufacturing company that maintains the association between car part serial numbers and an IMEI number can use that information to their benefit during a parts recall, in which case the affected cars may be tracked or even contacted using the IMEI number associated with the serial numbers of the affected parts. Once cellular communication is established with a piece of equipment that has been identified by its IMEI number, a message, instruction, or command may be sent to the equipment (or its user or operator). Likewise, information may be requested or received from the equipment (or its user or operator). Information may be communicated to and from the equipment with or without the user/operator's knowledge, permission, or interaction.

For manufacturing and sales, a piece of equipment may be configured such that a function, feature, or operation of the equipment is disabled until the association between an IMEI value for the equipment and a serial number for the equipment has been stored in the database. In this manner, the user/operator would be likely to actively ensure that the IMEI/SN association has been recorded and stored in the database.

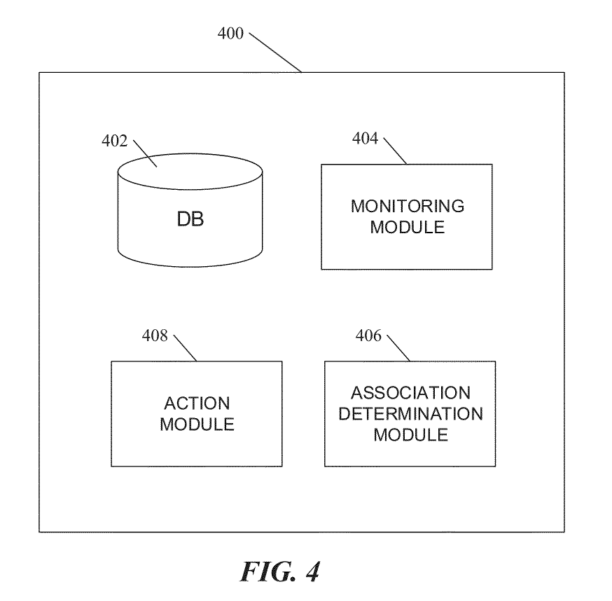

FIG. 4 is a block diagram illustrating an exemplary system for inventory control according to an embodiment of the subject matter described herein. In one embodiment, a system 400 for inventory control according to the principles described above may include a database 402, having hardware and storing and maintaining associations between international mobile equipment identity (IMEI) values and serial numbers for equipment associated with each IMEI value, a monitoring module 404 for monitoring signaling in a wireless network to determine observed associations between IMEI values and IMSI values, an association determination module 406 for determining, using the association between serial numbers and IMEI values, information about equipment associated with a particular serial number, and an action module 408 for performing a target action in response to determining that the observed association differs from the expected association.

For example, performing a target action in response to determining that the observed association differs from the expected association may include receiving, from the action module, sending an instruction to an entity other than the action module (not shown) that causes the target action to be performed by the entity. Performing the target action may also include providing notification of the discrepancy between the observed association and the expected association and/or recording or logging the occurrence of the discrepancy between the observed association and the expected association. In one embodiment, performing the target action may include performing an action related to a specific piece of equipment to which the monitored IMEI value is associated. This may include disabling or changing at least one of: an ability to communicate with the piece of equipment, an operation of the piece of equipment, a function or feature of the piece of equipment, a configuration of the piece of equipment, a network profile associated with the piece of equipment, or a network to which the piece of equipment may connect.

The systems and methods described herein may be embodied in a computer program product for signaling optimization in a wireless network utilizing proprietary and non-proprietary protocols. The computer program product may include a non-transitory computer readable storage medium having computer readable code embodied therewith, the computer readable code comprising computer readable program code configured to perform steps of the processes described above.

In one embodiment, for example, the computer program product may be in the form of a computer system within which a set of instructions, for causing the machine to perform any one or more of the methodologies discussed herein, may be executed. The computer system may include a processor, a memory, a non-volatile memory, and/or an interface device. The computer system can be of any applicable known or convenient type. The components of the computer system can be coupled together via a bus or through some other known or convenient device.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system. The interface can include an analog modem, ISDN modem, cable modem, token ring interface, satellite transmission interface (e.g. “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges. Likewise, the systems described above are for illustration only and are not limiting. Where a system has multiple modules, the division of labor between modules may be an arbitrary division for the purpose of simplicity of description. For example, for a system with a database and a monitoring module, it is understood that the functions of the database and monitoring module may reside together on a single physical unit (e.g., they may be co-located or co-resident), and that the functions of any module may reside across multiple physical units.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

What is claimed is:

1. A method for inventory control, the method including:
storing and maintaining expected associations between international mobile equipment identity (IMEI) values and international mobile subscriber identity (IMSI) values;
monitoring signaling in a wireless network;
determining observed associations between IMEI values and IMSI values based on the monitored signaling; and
determining whether an observed association involving an IMEI value and an IMSI value differs from the expected association for the IMEI or IMSI value; and
performing a target action in response to determining that the observed association differs from the expected association.

2. The method of claim 1 wherein performing a target action in response to determining that the observed association differs from the expected association includes:
selecting a target action a target action to be performed; and
sending an instruction that causes the target action to be performed.

3. The method of claim 1, wherein each IMEI value is associated with a respective piece of equipment.

4. The method of claim 1 wherein performing the target action includes providing notification of the discrepancy between the observed association and the expected association.

5. The method of claim 1 wherein performing the target action includes recording or logging the occurrence of the discrepancy between the observed association and the expected association.

6. The method of claim 1 wherein performing the target action includes performing an action related to a piece of equipment to which the IMEI value is associated.

7. The method of claim 6 wherein performing an action related to the piece of equipment to which the IMEI value is associated includes disabling or changing at least one of:
an ability to communicate with the piece of equipment;
an operation of the piece of equipment;
a function or feature of the piece of equipment;
a configuration of the piece of equipment;
a network profile associated with the piece of equipment; and
a network to which the piece of equipment may connect.

8. The method of claim 1 wherein the storing and maintaining steps are performed during a build step of a manufacturing process.

9. The method of claim 1 wherein the monitoring, determining, and performing steps are performed during at least one of:
a build step of a manufacturing process;
a product distribution process; and
a product deployment or lifecycle.

10. A system for inventory control, the system comprising:
a database having hardware and for storing and maintaining expected associations between international mobile equipment identity (IMEI) values and international mobile subscriber identity (IMSI) values;
a monitoring module for monitoring signaling in a wireless network to determine observed associations between IMEI values and IMSI values;
an association determination module for determining whether an observed association involving an IMEI value and an IMSI value differs from the expected association for the IMEI or IMSI value; and
an action module for performing a target action in response to determining that the observed association differs from the expected association.

11. The system of claim 10, wherein the target action is performed by the action module.

12. The system of claim 10, wherein the action module is configured for:
receiving, from the association determination module, notification that the observed association differs from the expected association;
determining the target action to be performed; and
performing the target action or sending an instruction that causes the target action to be performed by an entity other than the action module.

13. The system of claim 10 wherein each IMEI value is associated with a respective piece of equipment.

14. The system of claim 10 wherein performing the target action includes providing notification of the discrepancy between the observed association and the expected association.

15. The system of claim 10 wherein performing the target action includes recording or logging the occurrence of the discrepancy between the observed association and the expected association.

16. The system of claim 10 wherein performing the target action includes performing an action related to a piece of equipment to which the IMEI value is associated.

17. The system of claim 16 wherein performing an action related to the piece of equipment to which the IMEI value is associated includes disabling or changing at least one of:
an ability to communicate with the piece of equipment;
an operation of the piece of equipment;
a function or feature of the piece of equipment;
a configuration of the piece of equipment;
a network profile associated with the piece of equipment; and
a network to which the piece of equipment may connect.

18. The system of claim 10 wherein the storing and maintaining steps are performed during a build step of a manufacturing process.

19. The system of claim 10 wherein the monitoring, determining, and performing steps are performed during at least one of:
a product distribution process; and
a product deployment or lifecycle.

20. A non-transitory computer program product for inventory control, the computer program product comprising:
a non-transitory computer readable storage medium having computer readable code embodied therewith, the computer readable code comprising:
computer readable program code configured for:
storing and maintaining expected associations between international mobile equipment identity (IMEI) values and international mobile subscriber identity (IMSI) values;
monitoring signaling in a wireless network;
determining observed associations between IMEI values and IMSI values;
determining whether an observed association involving an IMEI value and an IMSI value differs from the expected association for the IMEI or IMSI value; and
performing a target action in response to determining that the observed association differs from the expected association.
